(19) United States
(12) Patent Application Publication
(10) Pub. No.: US 2025/0116762 A1
(43) Pub. Date: Apr. 10, 2025

(54) MEMS DEVICE, DISTANCE MEASUREMENT DEVICE, VEHICLE-MOUNTED DEVICE, AND METHOD FOR DRIVING MEMS DEVICE

(71) Applicant: SONY GROUP CORPORATION, TOKYO (JP)

(72) Inventors: TOMOKI ONO, TOKYO (JP); TSUBASA SUGIYAMA, TOKYO (JP)

(21) Appl. No.: 18/695,523

(22) PCT Filed: Sep. 12, 2022
(86) PCT No.: PCT/JP2022/033999

§ 371 Date: Mar. 26, 2024

(30) Foreign Application Priority Data
Oct. 8, 2021 (JP) 2021-165876

(51) Int. Cl. G01S 7/481; G01S 17/10; G01S 17/933

(52) U.S. Cl. CPC G01S 7/4817; G01S 17/10; G01S 17/933

(57) ABSTRACT

An object of the present invention is to improve accuracy of distance measurement. A MEMS device (100) includes a first mirror (101) and a second mirror (102), a first actuator (104) and a second actuator (107), and a first support section (103) and a second support section (105), in which the second mirror (102) is configured as a perforated mirror having an opening (118) at a center, and the first mirror (101) is disposed at the opening (118), the first actuator (104) is disposed between the first mirror (101) and the second mirror (102), the first support section (103) connects the first mirror (101) and the first actuator (104), the second support section (105) connects the second mirror (102) and the first actuator (104), and the second mirror (102) is connected to the second actuator (107) via a beam (108A, 108B, 109, 110A, 110B, 111A, 111B).

### TECHNICAL FIELD

The present disclosure relates to a MEMS device, a distance measurement device, a vehicle-mounted device, and a method for driving the MEMS device.

### BACKGROUND ART

Patent Document 1 discloses a distance measurement system that measures a distance to a distance measurement object (hereinafter, may be abbreviated as object).

### CITATION LIST

### Patent Document

Patent Document 1: Japanese Translation of PCT International Application Publication No. 2019-535014

### SUMMARY OF THE INVENTION

### Problems to be Solved by the Invention

In such a field, it is desired to improve accuracy of distance measurement.

An object of the present disclosure is to provide a MEMS device that can improve accuracy of distance measurement, a method for driving the MEMS device, a distance measurement device, and a vehicle-mounted device including the distance measurement device.

### Solutions to Problems

The present disclosure is, for example, a MEMS device including:
a first mirror and a second mirror;
a first actuator and a second actuator; and
a first support section and a second support section, in which
the second mirror is configured as a perforated mirror having an opening at a center, and the first mirror is disposed at the opening,
the first actuator is disposed between the first mirror and the second mirror,
the first support section connects the first mirror and the first actuator, and the second support section connects the second mirror and the first actuator, and
the second mirror is connected to the second actuator via a beam.

The present disclosure is, for example, a distance measurement device including:
a MEMS device;
a laser light source section;
a light receiving section; and
a measurement section configured to measure a distance to a distance measurement object on the basis of a flight time of a laser beam emitted from the laser light source section, in which
the MEMS device includes
a first mirror and a second mirror,
a first actuator and a second actuator, and
a first support section and a second support section, in which
the second mirror is configured as a perforated mirror having an opening at a center, and the first mirror is disposed at the opening,
the first actuator is disposed between the first mirror and the second mirror,
the first support section connects the first mirror and the first actuator, and the second support section connects the second mirror and the first actuator,
the second mirror is connected to the second actuator via a beam, and
the distance measurement object is irradiated with the laser beam by scanning the laser beam by the first mirror, and scattered light of the laser beam by the distance measurement object is reflected by the second mirror and enters the light receiving section.

The present disclosure is, for example,
a method for driving a MEMS device including a first mirror and a second mirror, a first actuator and a second actuator, and a first support section and a second support section, in which the second mirror is configured as a perforated mirror having an opening at a center, and the first mirror is disposed at the opening, the first actuator is disposed between the first mirror and the second mirror, the first support section connects the first mirror and the first actuator, the second support section connects the second mirror and the first actuator, and the second mirror is connected to the second actuator via a beam, in which
by vibrating the second actuator, the first mirror and the second mirror are integrally operated at a predetermined resonance frequency with a predetermined rotation axis, and the first actuator is non-resonantly driven in synchronization with the predetermined resonance frequency so that the first mirror operates prior to the second mirror by a predetermined phase difference on the predetermined rotation axis.

### BRIEF DESCRIPTION OF DRAWINGS

FIG. 1 is a diagram for describing a MEMS device according to one embodiment.

FIG. 2 is a partially enlarged view of the MEMS device according to the embodiment.

FIG. 3 is a diagram to be referred when an operation example of the MEMS device according to the embodiment is described.

FIG. 4 is a diagram to be referred when the operation example of the MEMS device according to the embodiment is described.

FIG. 5 is a diagram for describing a schematic configuration of a distance measurement device to which the MEMS device according to the embodiment may be applied.

FIGS. 6A and 6B are diagrams to be referred when a problem to be considered in the embodiment is described.

FIG. 7 is a diagram to be referred when the problem to be considered in the embodiment is described.

FIG. 8 is a diagram for describing an operation example of a mirror included in the MEMS device according to the embodiment.

FIG. 9 is a block diagram illustrating a configuration example of a mirror driving device according to the embodiment.

FIG. 10 is a block diagram illustrating a specific configuration example of a distance measurement system according to the embodiment.

FIG. 11 is a diagram to be referred when a connection example of actuators is described.

FIG. 12 is a diagram to be referred when the connection example of the actuators is described.

FIG. 13 is a diagram to be referred when the connection example of the actuators is described.

FIG. 14 is a diagram to be referred when the connection example of the actuators is described.

FIG. 15 is a diagram for describing a modification.

FIG. 16 is a diagram for describing a modification.

FIG. 17 is a diagram for describing a modification.

FIG. 18 is a diagram for describing an application example.

FIG. 19 is a diagram for describing an application example.

FIG. 20 is a diagram for describing an application example.

FIG. 21 is a diagram for describing an application example.

FIG. 22 is a block diagram illustrating an example of a schematic configuration of a vehicle control system.

FIG. 23 is an explanatory diagram illustrating an example of installation positions of an outside-vehicle information detecting section and an imaging section.

### MODE FOR CARRYING OUT THE INVENTION

Hereinafter, an embodiment and the like of the present disclosure is described with reference to the drawings. Note that the description will be given in the following order.

### Background of Present Disclosure

### One Embodiment

### Modifications

The embodiment and the like to be described below are preferred specific examples of the present disclosure, and the content of the present disclosure is not limited to the embodiment and the like. Note that, unless otherwise specified, patterns such as color shading or hatching in the drawings do not have a specific meaning. In addition, in consideration of convenience of description, there may also be a case where illustration is appropriately simplified, or only part of configurations is denoted by a reference sign.

### Background of Present Disclosure

First, a background of the present disclosure will be described in order to facilitate understanding of the present disclosure. A distance sensor of a time-of-flight measurement method (hereinafter, appropriately referred to as time of flight (ToF)) is used in various applications such as topographic measurement, structure management, autonomous navigation, defect inspection in production lines, sports, entertainment, or art. A pulse width of a laser gives a measurable time resolution. Since a speed of light is constant, the pulse width of the laser contributes to a distance resolution to be measured. For example, in a case where the speed of light is 3×108 m/s, when the time resolution is one nanosecond, the distance resolution is 15 cm, and when the time resolution is one picosecond, the distance resolution is 0.15 mm.

A coaxial optical system that biaxially scans the laser pulse with a scanning element and irradiates the object with the laser pulse and receives scattered light from the object via the scanning element is compact and has high measured position accuracy. Therefore, the coaxial optical system is often used for the distance sensor of the TOF method. As the scanning element, a galvano mirror driven by a solenoid or a small micro electro mechanical systems (MEMS) mirror is suitable. The galvano mirror may have a mirror area equal to or more than 100 mm², and is sufficiently larger than a cross-sectional area of an emission laser. Therefore, even an optical system that reflects scattered light from an object by the galvano mirror and then separates from the emission laser with a perforated mirror or the like has a large receiving opening size and can measure a remote distance exceeding 100 m.

On the other hand, since a sweep speed of the galvano mirror is low, in a case of a light source having a single luminous point, a point cloud density is low. A sweep speed of a small MEMS mirror is high, and it is possible to make the point cloud density be higher. However, a mirror diameter is small and is several mm, a maximum measurable distance is shortened.

Patent Document 1 describes a coaxial optical system using a plurality of MEMS mirrors. A central MEMS mirror emits a laser, and the scattered light from the object is deflected by the plurality of surrounding MEMS mirrors toward a light receiving element. These MEMS mirrors are synchronously controlled and can be used as a quasi-coaxial optical system. Furthermore, as compared with a case where a single MEMS mirror is used, the receiving opening size increases. By the way, a figure of merit of the MEMS mirror is given by a product of a mirror diameter, a vibration frequency, and a swing angle, and it is necessary to increase a Q value by a resonance operation in order to realize a high figure of merit. It has been known that the resonance frequency and the swing angle in the resonance operation are affected by variations in a semiconductor process. Therefore, it is not easy to synchronously drive the plurality of MEMS mirrors with the same resonance frequency and the desired swing angle, and it is not appropriate particularly for applications that require a compact size and low cost. Furthermore, since rotation centers of the plurality of MEMS mirrors are different, there is a problem, which is not small, of a multi-axis optical system in which a distance from the light receiving element to the object differs depending on the position of the object. That is, for applications that require distance accuracy of about several mm, it is necessary to individually correct time information from each light receiving element, according to the position of the object. Therefore, the technology described in Patent Document 1 has room for improvement in terms of improving accuracy of distance measurement. In view of such points, one embodiment of the present disclosure will be described in detail.

### One Embodiment

### [Configuration Example of MEMS Device]

### (Overall Configuration Example)

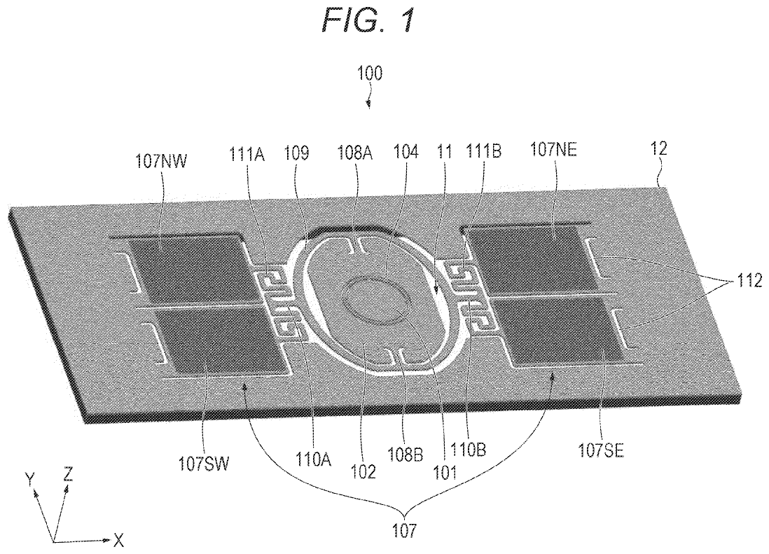

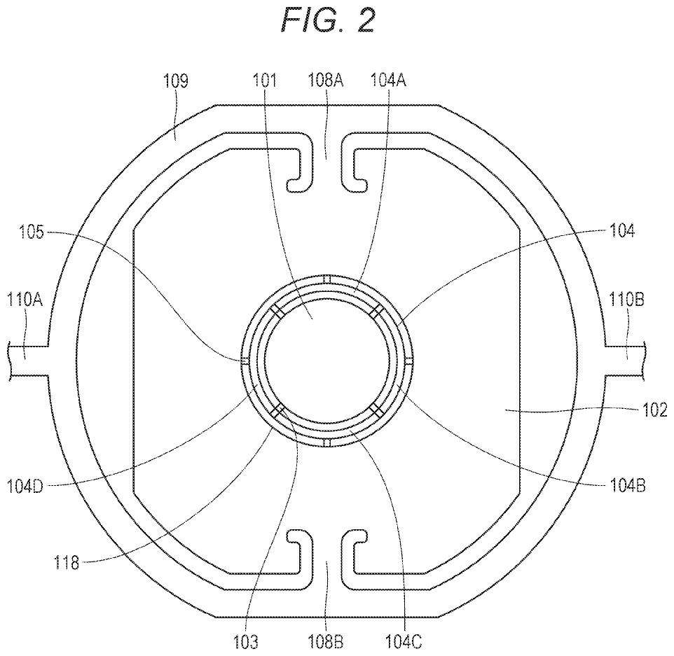

A MEMS device (MEMS device 100) according to an embodiment will be described with reference to FIGS. 1 and 2. The MEMS device 100 is created, for example, using a silicon on insulator (SOI), a frame includes a silicon substrate, an insulating layer, and a silicon device layer, and each portion inside the frame includes a silicon device layer. The silicon substrate and the insulating layer are removed. A first and second actuators to be described later are, for example, piezoelectric elements, and both electrodes arranged above and below the piezoelectric element are drawn to the frame and are connected to a predetermined MEMS driving device. The piezoelectric element that measures a torsion may be provided at roots of a first and second beams to be described later, and each of the electrodes arranged above and below is similarly drawn to the frame.

A specific configuration example of the MEMS device 100 will be described. The MEMS device 100 schematically includes a mirror section 11 and a frame 12 connected to the mirror section 11.

The mirror section 11 includes, for example, a first mirror 101, a second mirror 102, a first support section 103, a first actuator 104, a second support section 105, and a second actuator 107.

As illustrated in FIG. 2, the second mirror 102 is configured as a perforated mirror having an opening 118 at the center, and the first mirror 101 is disposed in the opening 118. The first actuator 104 is disposed between the first mirror 101 and the second mirror 102. The first mirror 101 and the first actuator 104 are connected by the first support section 103. The second mirror 102 and the first actuator 104 are connected by the second support section 105. The second mirror 102 is connected to the second actuator 107 via a beam.

The first mirror 101 has, for example, a substantially circular shape. A diameter of the first mirror is, for example, about two mm. A dimension of the first mirror 101 is not limited to the above, and the diameter may be about one mm to three mm, and the shape is desirably a circular shape or an elliptical shape. The first actuator 104 is disposed around the first mirror 101. The first actuator 104 is formed in divided four regions (first region 104A to fourth region 104D) on a ring-like silicon substrate.

The number of regions of the first actuator 104 does not need to be four. It is sufficient that the first actuator 104 be divided into at least two parts. Furthermore, the first actuator 104 has a shape symmetrical with respect to a center line passing through the center of the first mirror 101. The first support section 103 is connected to the silicon substrate between the first actuator 104 in the four regions, for example. The first support section 103 may be directly connected to the four-region first actuator 104. Furthermore, the second support section 105 is connected to the vicinity of a center of an outer edge of each of the four regions of the first actuator 104. The second support section 105 is connected to a peripheral surface of the opening 118 of the second mirror 102. The first support section 103 and the second support section 105 are provided at alternate positions.

The first actuator 104 has a width of 100 μm, and is provided for each of the first mirror 101 and the second mirror 102 in a space of 50 μm. An operation range of the first actuator 104 is narrow, and even if the space is less than 50 μm, an operation is not hindered.

The second mirror 102 schematically has an H-like (elliptical) shape. The second mirror 102 has a size of about four mm length in a horizontal direction×six mm length in a vertical direction. Dimensions of the second mirror 102 are not limited to the above, and the size may be about three mm×10 mm, and the shape is desirably a circular shape, an elliptical shape, or a free shape. The second mirror 102 is connected to first beams 108A and 108B extending in a direction of a horizontal rotation axis (axis in Y-axis direction when mirror section 11 rotates in horizontal direction) at two points (opposing two points). The first beams 108A and 108B are connected to a ring-like beam 109. The ring-like beam 109 is disposed so as to surround the second mirror 102. The ring-like beam 109 is connected to second beams 110A and 110B extending in a direction of a vertical rotation axis (axis in X-axis direction when mirror section 11 rotates in vertical direction) at two points (opposing two points). The second beam 110A is connected to the vicinity of the center of an accordion-like snake beam 111A. Furthermore, the second beam 110B is connected to the vicinity of the center of an accordion-like snake beam 111B.

The second actuator 107 includes, for example, two actuators (second actuators 107NW and 107SW) provided on one side in the X-axis direction and two actuators (second actuators 107NE and 107SE) provided on another side in the X-axis direction. Note that, in a case where it is not necessary to distinguish the individual actuators, the actuators are referred to as the second actuator 107. For example, one end of the snake beam 111A is connected to the second actuator 107NW, and another end of the snake beam 111A is connected to the second actuator 107SW. Furthermore, one end of the snake beam 111B is connected to the second actuator 107NE, and another end of the snake beam 111B is connected to the second actuator 107SE.

### (Operation of MEMS Device)

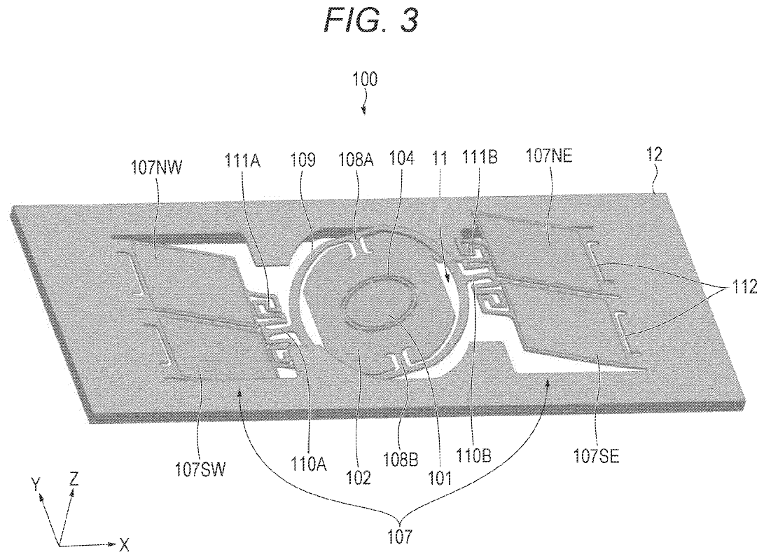

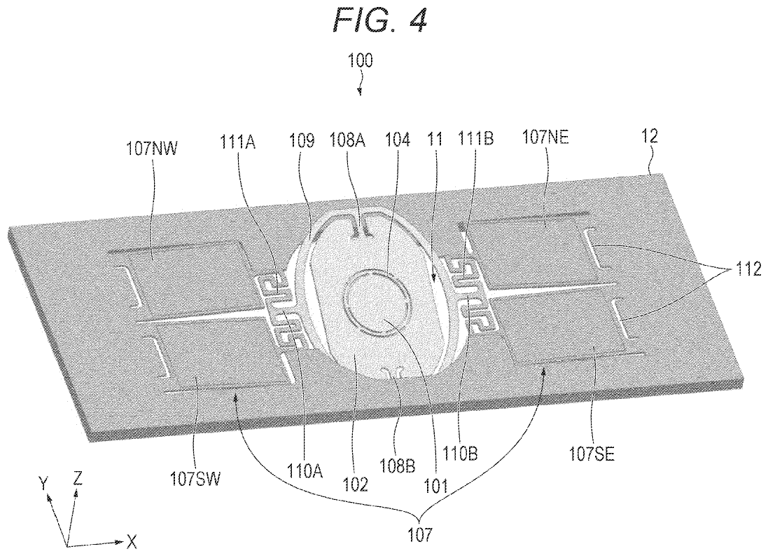

Next, an operation of the MEMS device 100 will be schematically described with reference to FIGS. 3 and 4. When the second actuators 107NE and 107SE are driven in the same phase and the second actuators 107NW and 107SW are driven in a phase opposite to a signal for driving the second actuators 107NE and 107SE, horizontal torsion vibration occurs (refer to FIG. 3). Furthermore, when the second actuators 107NE and 107NW are driven in the same phase and the second actuators 107SE and 107SW are driven in a phase opposite to a phase of a signal for driving the second actuators 107NE and 107NW, vertical torsion vibration occurs (refer to FIG. 4). By combining the horizontal torsion vibration and the vertical torsion vibration, the mirror section 11 can be two-dimensionally vibrated in any direction.

By driving the horizontal torsion vibration and the vertical torsion vibration at a natural vibration frequency or in the vicinity thereof, resonance torsion occurs, and a large swing angle can be obtained. By adding and applying a horizontal and vertical driving voltages, biaxial torsion vibration occurs. Although occupied areas of the snake beams 111A and 111B are small, the snake beams 111A and 111B efficiently convert a vertical operation of the second actuator 107 into a biaxial torsion operation. In a general snake beam that repeatedly reciprocates in a horizontal or vertical direction, a difference in a spring constant between the horizontal rotation axis and the vertical rotation axis increases, and it is difficult to balance a biaxial swing angle. However, as the snake beams 111A and 111B, by combining the snake beam extending in the horizontal rotation axis direction and the snake beam extending in the vertical rotation axis direction, it is possible to balance the biaxial swing angle. Preferably, portions of the snake beams 111A and 111B extending from the second beams 110A and 110B are folded in parallel to the ring-like beam 109, and the second beams 110A and 110B are vertically folded on the side of the second actuator 107. As a result, a vertical swing angle can be increased.

As illustrated in FIG. 1, in the MEMS device 100 according to the present embodiment, a slit 112 is provided between the second actuator 107 and an end of the frame 12, and the second actuator 107 serves as a weak spring. With this configuration, coupled vibration of five mass points including the four second actuators 107 and the mirror (first mirror 101 and second mirror 102) is generated. In a structure with no slit 112, the second actuator 107 and the frame 12 are connected with a strong spring.

In a case where a long axis of an outer size of the second mirror 102 is set to six mm and a short axis is set to four mm, torsion vibration illustrated in FIG. 3 and torsion vibration illustrated in FIG. 4 respectively have a natural vibration frequency around 1.9 kHz and a natural vibration frequency around 1.0 kHz. The natural vibration frequency can be adjusted by a thickness or a shape of the beam, a thickness of the silicon device layer, or the like and can be designed according to an application. Furthermore, by designing a higher order frequency of a resonance frequency on a low frequency side to be sufficiently separated from a resonance frequency on a high frequency side, it is possible to control biaxial resonance.

By the way, it can be confirmed from a simulation result that the first mirror 101 and the second mirror 102 that are resonantly operated by the second actuator 107 integrally generate biaxial (horizontal rotation axis and vertical rotation axis) torsion vibration. The natural vibration frequencies (resonance frequency) of horizontal rotation and vertical rotation are designed to be about 0.5 to five kHz, whereas natural vibration frequencies of the first actuator 104, the first support section 103, and the second support section 105 are about 100 kHz and high. Therefore, in a case where a driving voltage is applied to resonate the horizontal rotation and the vertical rotation, natural vibration of the first actuator 104 is not excited. The natural vibration frequency depends on a length of the first actuator 104, and is preferably at least equal to or more than 20 kHz.

In a case where the mirror section 11 is vertically rotated, the first region 104A and the third region 104C of the first actuator 104 are driven in synchronization with the resonance frequency of the vertical rotation. Accordingly, the first actuator 104 is non-resonantly driven. As a result, around the vertical rotation axis, the first mirror 101 performs torsion vibration slightly before the second mirror 102, with a first phase difference. In a case where the mirror section 11 is horizontally driven, the second region 104B and the fourth region 104D of the first actuator 104 are driven in synchronization with the resonance frequency of the horizontal rotation. Accordingly, the first actuator 104 is non-resonantly driven. As a result, around the horizontal rotation axis, the first mirror 101 performs the torsion vibration slightly before the second mirror 102 with a second phase difference.

(Schematic Configuration of Distance Measurement Device to which MEMS Device May be Applied)

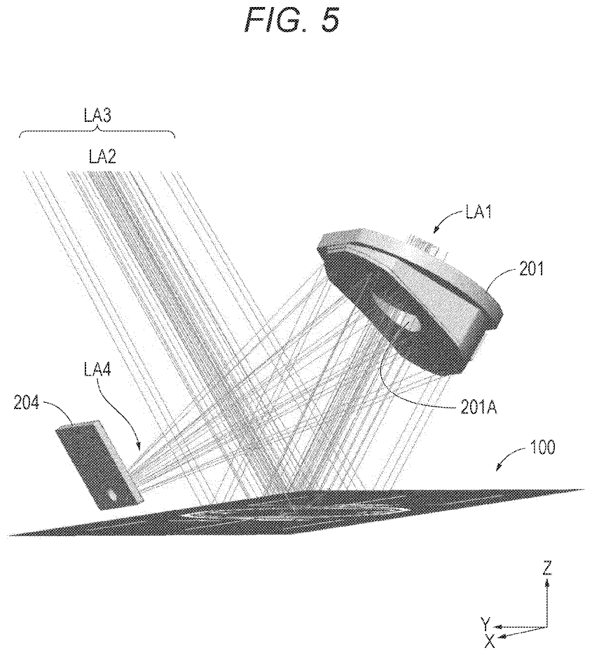

A schematic configuration of a distance measurement device to which the MEMS device 100 may be applied will be described with reference to FIG. 5. An incident laser LA1 emitted from a light source (not illustrated) passes through an opening 201A of a perforated parabolic mirror 201, and an emission laser LA2 reflected by the first mirror 101 is obtained. Scattered light LA3 from an object (distance measurement object) is reflected by the first mirror 101 and the second mirror 102, the light reflected by the second mirror 102 is collected by the perforated parabolic mirror 201 that is an example of a light collecting section, and the collected light LA4 passes through an aperture 204. The light that has passed through the aperture 204 is received by a light receiving element (not illustrated) such as a silicon photomultiplier and is converted into an electric signal. The light reflected by the first mirror 101 passes through the opening 201A of the perforated parabolic mirror 201. Note that it is possible to transmit the incident laser LA1 by providing a polarization dependence film as a portion of a paraboloid, without providing the opening 201A in an opening portion of the perforated parabolic mirror 201 and to collect about a half of the scattered light from the object reflected by the first mirror 101.

The aperture 204 is a basic optical component that increases a ratio of the scattered light LA3 from the object with respect to external light, that is, improves a signal noise ratio (S/N) and increases acceptance angles of the aperture 204 and the perforated parabolic mirror 201 to be larger than a divergence angle of the emission laser LA2. Note that, in a case where the plurality of light receiving elements and the plurality of apertures are used, the acceptance angle of each aperture is decreased by the number of elements. Therefore, if a radiation pattern of the laser is a unimodal Gaussian beam with two orthogonal axes, the divergence angle of the emission laser LA2 is minimized with respect to the same beam waist, and an appropriate aperture size is also reduced. If a diameter of the first mirror 101 is set to two mm and a beam waist (radius when intensity is 1/e2) is set to 0.8 mm, a divergence angle (half angle) θ1 of the emission laser at a wavelength 830 mm is 0.33 mrad. If a focal distance of the perforated parabolic mirror 201 is set to 12 mm, an ideal minimum size of the aperture 204 is a radius of 4.0 μm. The radius of the aperture 204 may be actually optimized within a range of 4.0 μm to 15.0 μm, in consideration of surface accuracy of the mirror of the MEMS device 100 and surface accuracy of the perforated parabolic mirror 201.

### [Detailed Operation of MEMS Device]

Next, a detailed operation of the MEMS device 100 that is applied to the distance measurement device described above will be described with reference to points to be considered in the present embodiment.

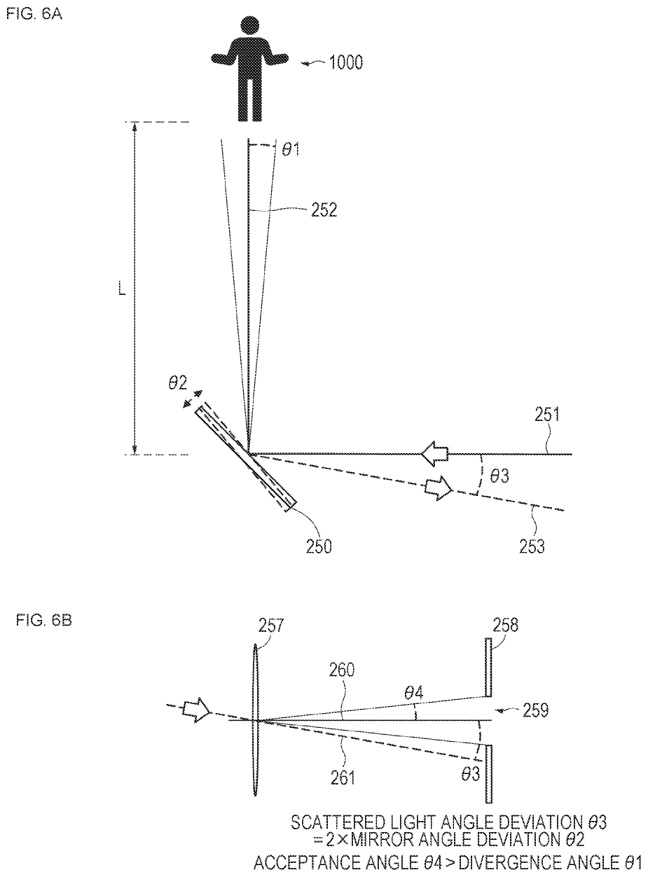

In general, an angular velocity of the MEMS mirror (general MEMS mirror 250) increases, as illustrated in FIG. 6A, an incident laser and an emission laser passing on an optical axis 251 are deflected by the MEMS mirror 250, pass on an optical axis 252, and are scattered by a distance measurement object 1000, and then returns on the optical axis 252, and when being deflected by the MEMS mirror 250 again, the optical axis of the reflected light does not overlap the optical axis 251, like an optical axis 253. This is because an angle of the MEMS mirror 250 is slightly rotated by θ2 within a time in which light reciprocates a distance L to the distance measurement object 1000. The rotation causes an angular difference θ3 that is a deviation of optical axis, by 2×θ2. As illustrated in FIG. 6B, a position of an optical axis 261 of scattered light is deviated from an optical axis 262 by about θ3, from an aperture center 259 of an aperture 258 with a light collecting element 257 including a lens, a parabolic mirror, or the like.

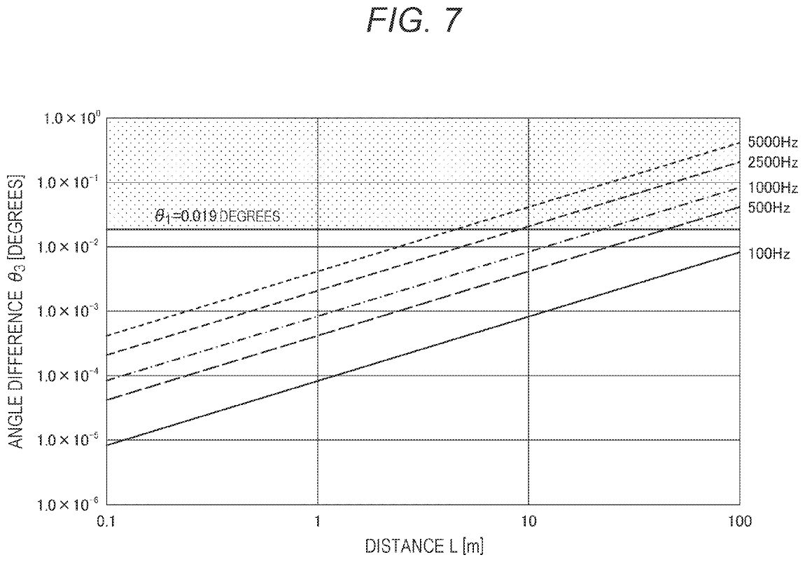

Since a maximum angular velocity of the MEMS mirror that performs an ideal resonance operation is given at the center (zero degrees), the maximum angular speed is 2×π×f×A from a resonance frequency f and a maximum mechanical swing angle A. It is assumed that the maximum mechanical swing angle A (half angle) be 10 degrees, dependency of the distance L to the object with the angular difference θ3 is illustrated in FIG. 7.

A horizontal axis of a graph illustrated in FIG. 7 indicates the distance L [m], and a vertical axis indicates the angular difference θ3 [degrees]. FIG. 7 illustrates five cases of 100 Hz, 500 Hz, 1000 Hz, 2500 Hz, and 5000 Hz as the resonance frequency f. The divergence angle 0.33 mrad of the emission laser is converted into 0.0019 degrees and illustrated. Under the most severe condition of θ4=θ1, a dot is added to a region in which the angular difference θ3 exceeds θ1 and the scattered light cannot be taken by the aperture.

A resonant basic mode of a silicon-based MEMS mirror is about 1000 Hz to 2500 Hz, and as illustrated in FIG. 7, when the distance to the distance measurement object becomes longer than several tens of meters, light cannot be taken. That is, a maximum distance sensitivity is significantly affected, in applications of the distance sensor of the time-of-flight measurement method (ToF) such as sports, entertainment, art, defect inspection in production line, topographic measurement using drones, structure management, or autonomous navigation.

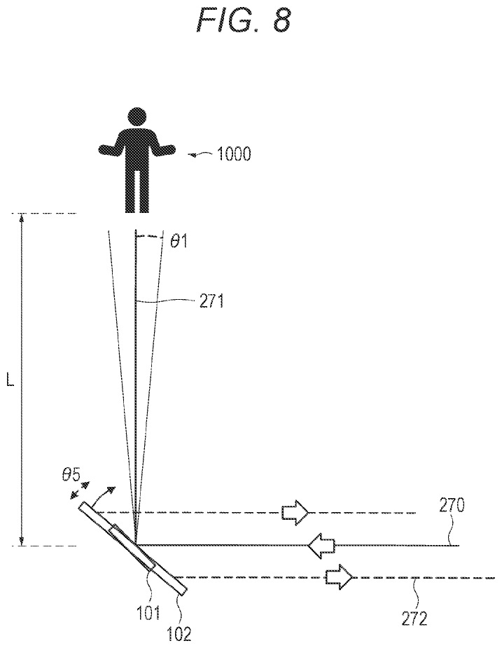

In this regard, as illustrated in FIG. 8, in the MEMS device 100 according to the present embodiment, the first mirror 101 and the second mirror 102 in which the first mirror 101 is disposed at the center are provided, and the first mirror 101 is operated prior to the second mirror 102 by a phase p. That is, as illustrated in FIG. 8, the first mirror 101 is operated prior to the second mirror 102 at an angle θ5 at the angle center. In a case where control is performed such that θ2=θ5, as illustrated in FIG. 8, the incident laser and the emission laser that pass on an optical axis 270 are deflected by the first mirror 101, pass on an optical axis 271, and are scattered by the distance measurement object 1000. When the scattered light passes on the optical axis 271 again and is deflected by the second mirror 102, an optical path of the reflected light is as indicated by 272, and a ring-like pattern optical axis coincides with the optical axis 270 of the incident laser.

Therefore, even in the region to which the dots are added in FIG. 7, the scattered light can be taken by the aperture. That is, it is possible to measure a distance to an object located several tens m ahead by improving the maximum distance sensitivity, in the applications of the distance sensor of the ToF such as sports, entertainment, art, defect inspection in production lines, topographic measurement using drones, structure management, or autonomous navigation. That is, it is possible to improve accuracy of distance measurement and measure a distance to a distant object.

### [Specific Configuration Example of Mirror Driving Device]

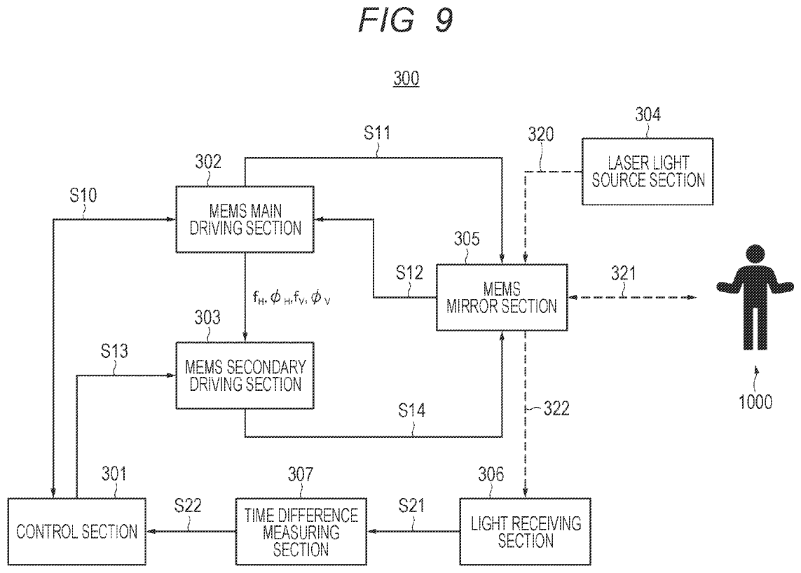

FIG. 9 is a block diagram illustrating a specific configuration example of a mirror driving device (mirror driving device 300) that drives the first mirror 101 and the second mirror 102. The mirror driving device 300 may be applied to the distance measurement device. Note that a solid arrow in FIG. 9 indicates a flow of a control signal or data, and a dotted line arrow indicates an optical path of light to be propagated. Furthermore, “main/sub” is added to some configurations, this is for convenience of description, and this does not have a specific meaning such as dependency, unless otherwise specified.

The mirror driving device 300 includes a control section 301, a MEMS main driving section 302, a MEMS secondary driving section 303, a laser light source section 304, a MEMS mirror section 305, a light receiving section 306, and a time difference measuring section 307.

The control section 301 integrally controls an overall operation of the mirror driving device 300. The MEMS main driving section 302 and the MEMS secondary driving section 303 drive the MEMS mirror section 305. The laser light source section 304 is a light source that emits laser light. The MEMS mirror section 305 includes the first mirror 101, the second mirror 102, the first actuator 104, and the second actuator 107. The light receiving section 306 is a light receiving element that receives the scattered light from the distance measurement object 1000 and includes an aperture. The time difference measuring section 307 measures a round-trip flight time of light according to the ToF method. The time difference measuring section 307 includes a signal forming section that forms a signal waveform.

Setting information S10 such as a maximum mechanical swing angle or a frequency is transmitted from the control section 301 to the MEMS main driving section 302, and a drive signal S11 for the second actuator 107 is transmitted from the MEMS main driving section 302 to the MEMS mirror section 305. A torsion sensor signal S12 is transmitted from the MEMS mirror section 305 to the MEMS main driving section 302, and closed loop control is performed. Note that the torsion sensor signal S12 may be supplied from another sensor section different from the second actuator 107, or the second actuator 107 may be time-divided and use both driving and a sensor.

Information such as the maximum mechanical swing angle, the frequency, or the phase is returned from the MEMS main driving section 302 to the control section 301, for each predetermined period. Setting information S13 such as a preceding phase of the first mirror 101 with respect to the second mirror 102 is transmitted from the control section 301 to the MEMS secondary driving section 303 at an initial stage or for each period. The biaxial frequency and the phase are transmitted from the MEMS main driving section 302 to the MEMS secondary driving section 303 for each period, and a drive signal S14 is transmitted from the MEMS secondary driving section 303 to the first actuator 104 of the MEMS mirror section 305. Note that the first actuator 104 is non-resonantly driven.

A laser pulse from the laser light source section 304 enters the MEMS mirror section 305 via an optical path 320. The laser pulse is generated at a period in consideration of a round-trip time of a maximum measurement distance and a dead time for refreshing each measurement system, non-synchronous driving with the MEMS mirror section 305, synchronous driving with a fixed phase, and phase-swept synchronous driving may be performed. In the present embodiment, any driving method can be applied.

The distance measurement object 1000 is irradiated with the laser emitted from the MEMS mirror section 305 through an optical path 321, and scattered light from the object returns through the optical path 321 and is taken and received by the light receiving section 306 via an optical path 322 including a perforated parabolic mirror from the MEMS mirror section 305. An electric pulse signal S21 photoelectrically converted by the light receiving section 306 is transmitted to the time difference measuring section 307, and a time difference from a laser pulse emission time (laser emission timing from laser light source section 304) separately obtained, that is, a round-trip flight time of light from the MEMS mirror section 305 to the distance measurement object 1000 is calculated. Flight time information S22 indicating a flight time is supplied from the time difference measuring section 307 to the control section 301. Together with the flight time information S22, intensity information of the electric pulse signal photoelectrically converted by the light receiving section 306 may be simultaneously supplied to the control section 301. The control section 301 can change the preceding phase (phase difference) of the first mirror 101 with respect to the second mirror 102 to be transmitted to the MEMS secondary driving section 303, using one or both of the flight time and the intensity information that are obtained. That is, according to the distance to the distance measurement object 1000, the phase difference between the first mirror 101 and the second mirror 102 can be changed. Furthermore, the control section 301 measures the distance to the distance measurement object 1000, for example, by multiplying the flight time information S22 by a light speed and multiplying a calculation result by ½.

### [Specific Configuration Example of Distance Measurement System]

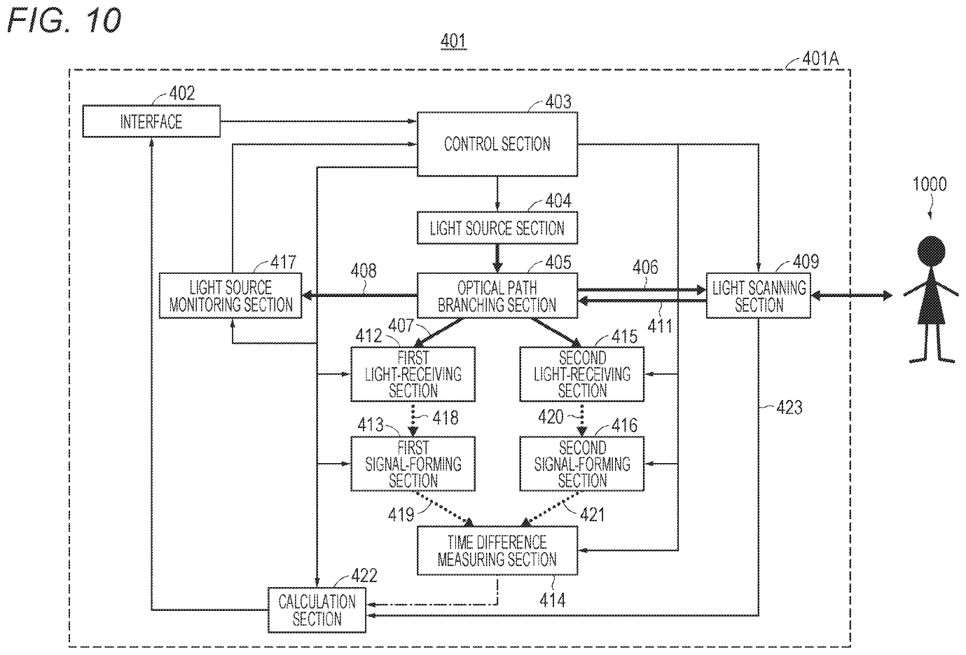

FIG. 10 is a diagram illustrating a specific configuration example of a distance measurement system in a case where the mirror driving device 300 described above is applied to a distance measurement system (distance measurement system 401). In FIG. 10, a solid arrow indicates a control signal, a thick arrow indicates an optical path, a broken arrow indicates a signal line, and a dashed-dotted arrow indicates a data line. The distance measurement system 401 includes a distance measurement device 401A and the distance measurement object 1000. The distance measurement device 401A includes an interface 402, a control section 403, a light source section 404, an optical path branching section 405, a light scanning section 409, a first light-receiving section 412, a first signal-forming section 413, a time difference measuring section 414, a second light-receiving section 415, a second signal-forming section 416, a light source monitoring section 417, and a calculation section 422.

The interface 402 is an interface used when the distance measurement device 401A and an external device exchange data and commands with each other. The control section 403 integrally controls the entire distance measurement device 401A. An operation of each section of the distance measurement device 401A is controlled by the control section 403.

The control section 403 that has received a control parameter from the outside via the interface 402 transmits a control signal to a plurality of devices and circuits to be described later. The light source section 404 includes a Q-switched semiconductor light-emitting element and a driving circuit, has a pulse width of sub-nanoseconds, desirably, equal to or less than 20 picoseconds, and emits pulsed light with high beam quality having pulse energy of several hundred picojoules to several nanojoules.

In the optical path branching section 405, light from the light source section 404 is branched into measurement light 406 emitted to the distance measurement object 1000 via a beam splitter or the like, reference light 407 for obtaining a start signal of time measurement, and control light 408 for controlling the light source. The measurement light 406 is transmitted to the light scanning section 409, and is sequentially emitted to a designed field of view (FOV) range. The measurement light 406 emitted to the distance measurement object 1000 such as a person or the like is scattered. A part of the scattered light passes through the light scanning section 409 and becomes detection light 411.

The reference light 407 is transmitted to the first light-receiving section 412 and converted into a reference electric signal 418 by a light receiving element such as a photodiode, an avalanche photodiode, or an SiPM. The reference electric signal 418 is transmitted to the time difference measuring section 414 via the first signal-forming section 413. The detection light 411 is transmitted to the second light-receiving section 415 and converted into a detection electric signal 420 by a light receiving element such as an SiPM. The detection electric signal 420 is transmitted to the time difference measuring section 414 via the second signal-forming section 416. As described later, the second signal-forming section 416 amplifies a very weak detection electric signal 420 by single photon detection to be described later, with a high S/N and low jitter.

The first signal-forming section 413 amplifies the reference electric signal 418 that has an analog waveform output from the light receiving element, and generates a reference rectangular wave 419 on the basis of a detection threshold that is arbitrarily set. The second signal-forming section 416 amplifies the detection electric signal 420 that has an analog waveform output from the light receiving element, and generates a detection rectangular wave 421 on the basis of a detection threshold that is arbitrarily set. The control light 408 is transmitted to the light source monitoring section 417, pulse energy and a pulse width are measured, and information is returned to the control section 403. The number of rectangular waves each transmitted to the time difference measuring section 414 may be one or two or more, and these may be different rectangular waves obtained with two or more detection thresholds. The time difference measuring section 414 uses a TDC to measure a relative time of the input rectangular wave. This is a time difference between the reference rectangular wave 419 and the detection rectangular wave 421, or a time difference between a separately prepared clock and the reference rectangular wave or between the clock and the detection rectangular wave. These are different depending on the kind of the TDC. For the TDC, a counter method alone, a method of calculating an average value by performing measurement a plurality of times using the counter method and an inverter-based ring-delay-line, a method of combining the counter method with a highly accurate measurement method having a picosecond resolution, such as vernier buffering or pulse shrink buffering, or the like is used. In addition, the time difference measuring section 414 may have a function of measuring a rise time of the detection electric signal 420 output from the second light-receiving section 415, measuring a peak value, or measuring a pulse integral value. These can be measured by the TDC or an analog to digital converter (ADC).

The time difference measured by the time difference measuring section 414 is transmitted to the calculation section 422. The calculation section 422 performs offset adjustment, performs time-walk error correction using a rise, a peak value, a pulse integral value, and the like of the detection electric signal 420, and performs temperature correction. Then, the calculation section 422 performs vector calculation using scanning timing information 423 transmitted from the light scanning section 409. Incidentally, distance data and scanning angle data may be output from the interface 402 without performing the vector calculation. In addition, appropriate processing such as noise removal, averaging with adjacent points, interpolation, and the like may be performed on these pieces of data, or advanced algorithms such as recognition processing may be performed thereon.

Note that phase difference information between the first mirror 101 and the second mirror 102 obtained from a target value of the distance measurement object 1000 may be transmitted from the control section 403 to the light scanning section 409, and the phase difference information can be transmitted in advance or in real time. As a result, it is possible to acquire distance data of the farther distance measurement object 1000.

Note that the configuration of the distance measurement system 401 and the configuration of the mirror driving device 300 that execute similar processing may correspond to each other.

### [Connection Example of Actuator]

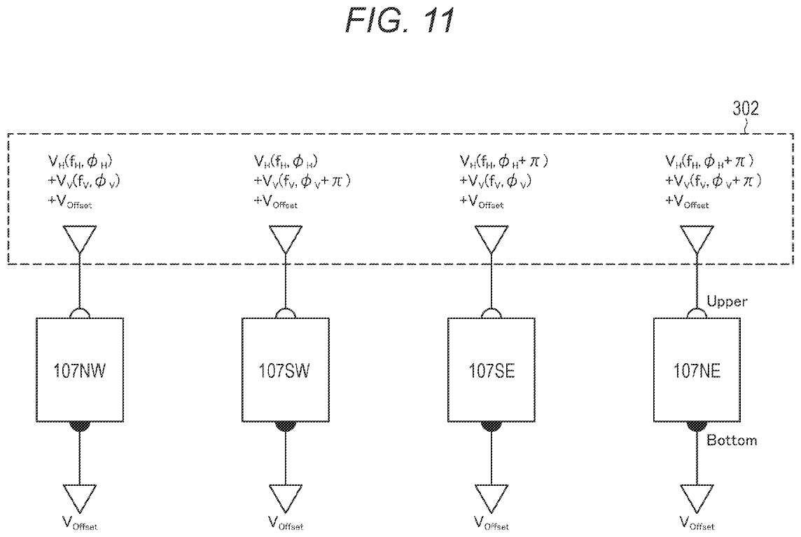

Next, a connection example of the actuators will be described with reference to FIGS. 11 to 14. Note that, in each drawing, a terminal of an upper electrode of the piezoelectric element configuring each actuator is illustrated as a white circle, and a terminal of a lower electrode on a substrate side is illustrated as a black circle.

FIG. 11 illustrates a specific example of a connection form example between the MEMS main driving section 302 and each of the four second actuators 107 and a voltage to be applied. The terminal of the upper electrode of the piezoelectric element of each actuator is illustrated as a white circle, and the terminal of the lower electrode on the substrate side is illustrated as a black circle. A voltage to be applied to each actuator is given by adding a voltage VH for horizontal driving, a frequency fH, a phase φH, a voltage VV for vertical driving, a frequency fv, a phase φV, and an offset voltage VOffset. Each voltage for driving has a Sin waveform, pulse width modulation (PMW), a half wave (waveform obtained by cutting of positive voltage or negative voltage with zero amplitude as boundary), or a free waveform, and each frequency is stably driven by phase locked loop (PLL) or the like.

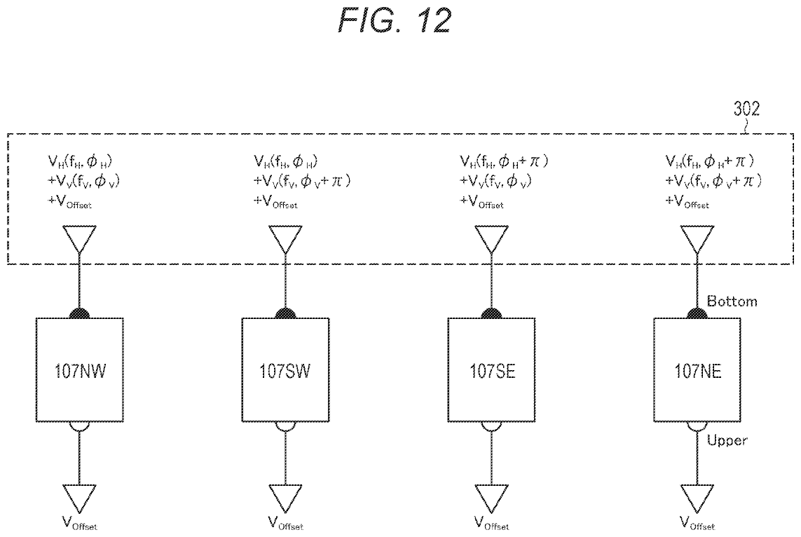

FIG. 12 illustrates a specific example or the like of a voltage in a case where the upper electrode is short-circuited to the ground and the driving voltage is applied to the lower electrode. Each voltage for driving has a Sin waveform, pulse width modulation (PMW), a half wave (waveform obtained by cutting of positive voltage or negative voltage with zero amplitude as boundary), or a free waveform, and each frequency is stably driven by phase locked loop (PLL) or the like.

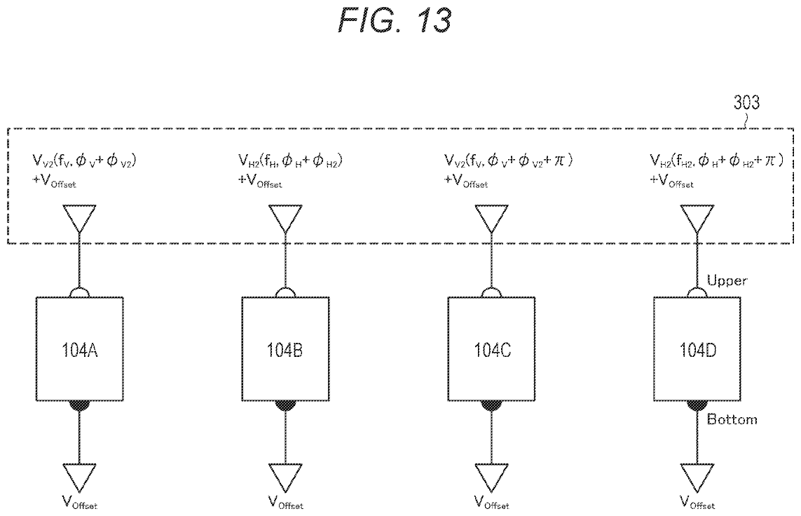

FIG. 13 illustrates a specific example of a connection form example between the MEMS secondary driving section 303 and each of the four first actuators 104 and a voltage to be applied. In order to control a preceding operation of the first mirror 101 that vertically rotates, a voltage VV2 (driving frequency is driving frequency fV synchronized with second actuator 107, and phase is obtained by adding phase φV of second actuator and phase φV2 obtained by adding phase delay caused by deformation including beam and preceding operation) is given to the first region 104A of the first actuator 104.

The third region 104C of the first actuator 104 controls the preceding operation of the first mirror 101 that vertically rotates, and has a phase preceding from the first region 104A by n. In order to control the preceding operation of the first mirror 101 that horizontally rotates, a voltage VH2 (driving frequency is driving frequency fH synchronized with second actuator 107, and phase is obtained by adding phase φH of second actuator 107 and phase φH2 obtained by adding phase delay due to deformation including beam and preceding operation) is given to the second region 104B of the first actuator. Since the fourth region 104D of the first actuator 104 controls the preceding operation of the first mirror 101 that horizontally rotates, and a phase precedes from the second region 104B by π.

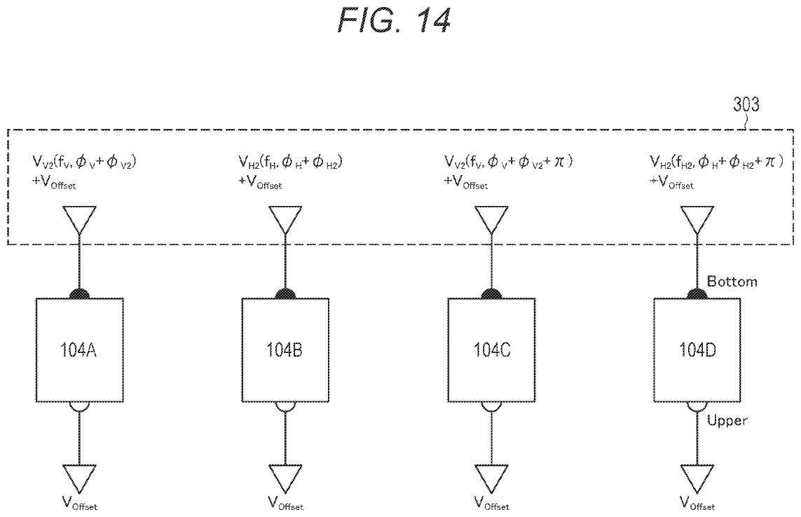

FIG. 14 illustrates a specific example of a voltage or the like in a case where the upper electrode is short-circuited to the ground and the driving voltage is applied to the lower electrode. Note that, in FIGS. 13 and 14, the first actuator 104 may be formed in a recess or protruding shape using a residual stress of a process and may be changed from the protruding shape to a flat shape or from a flat shape to the recess with a plus or minus single power supply. The unevenness of the first actuator 104 gives a phase difference to the first mirror 101 and the second mirror 102 via the first support section 103 and the second support section 105.

### Modifications

Although the one embodiment of the present disclosure has been specifically described above, the content of the present disclosure is not limited to the embodiment described above, and various kinds of modifications based on the technical idea of the present disclosure are possible. Hereinafter, modifications will be described.

### [Modification 1]

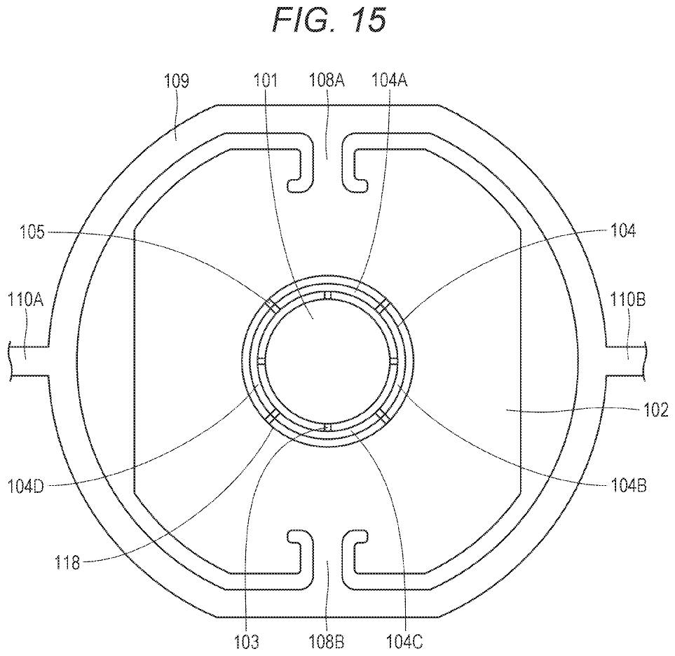

FIG. 15 is a diagram for describing a modification of the mirror section 11. A difference from the embodiment is a point that positions where the first support section 103 and the second support section 105 are provided are different. The positions where the first support section 103 and the second support section 105 are provided can be any positions. Note that, as the method for driving the mirror section 11, the driving method described in the embodiment can be applied.

### [Modification 2]

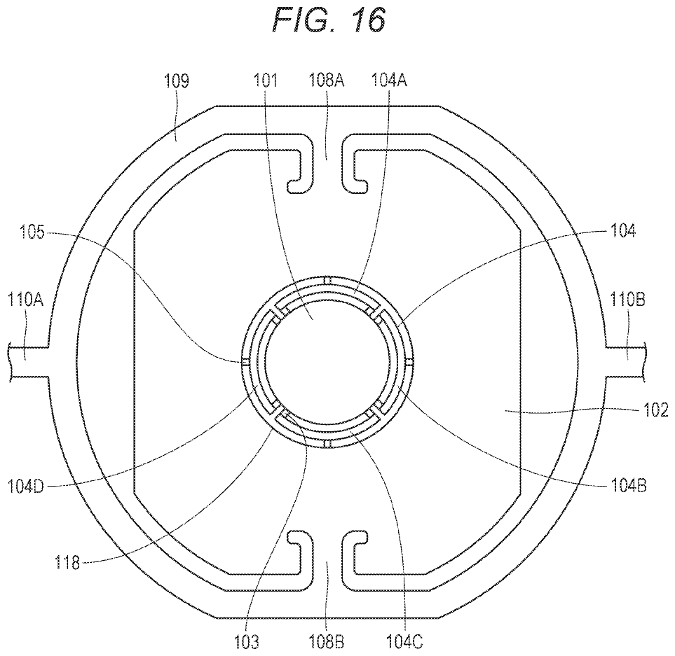

FIG. 16 is a diagram for describing another modification of the mirror section 11. In the present modification, the silicon device layer between each of the regions including the first region 104A, the second region 104B, the third region 104C, and the fourth region 104D of the first actuator 104 is removed, and the regions are completely separated. Note that, as the method for driving the mirror section 11, the driving method described in the embodiment can be applied.

### [Modification 3]

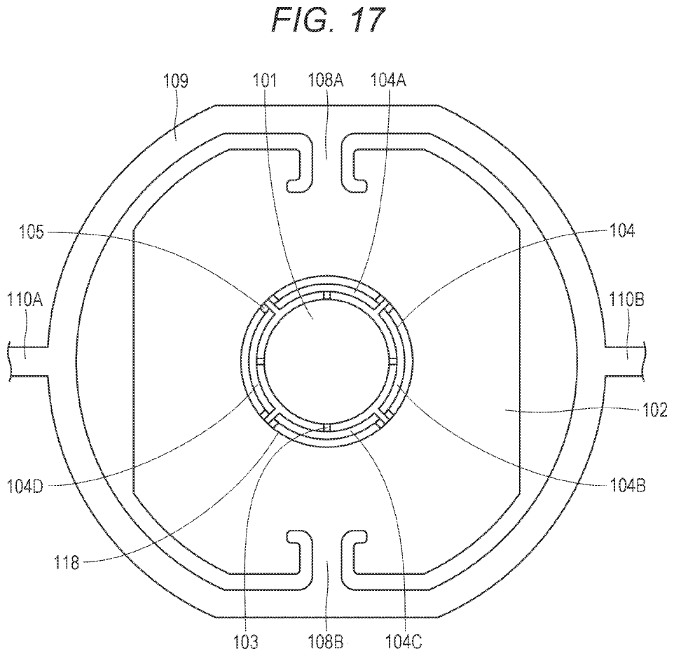

FIG. 17 is a diagram for describing still another modification of the mirror section 11. In the present modification, the silicon device layer between each of the regions including the first region 104A, the second region 104B, the third region 104C, and the fourth region 104D of the first actuator 104 is removed, and the regions are completely separated. Furthermore, the eight second support sections 105 are provided. For example, the two second support sections 105 connect an outer end of the first region 104A of the first actuator 104 and the peripheral surface of the opening 118 of the second mirror 102. The other second support sections 105 similarly connects a predetermined corresponding region of the first actuator 104.

### [Modification 4]

As the distance sensor to which the MEMS device 100 described in the embodiment or the modifications is applied, various methods can be applied. For example, the ToF method is classified into several types, and in particular, a direct time-of-flight measurement method (d-ToF) in which a pulsed laser is emitted is subdivided into a linear mode (LM), a Geiger mode (GM), and a single photon (SP) (appropriately referred to as LM method, GM method, and SP method, respectively). In the LM method, a linear light receiving element such as an avalanche photodiode (APD) is used, and the number of photons N with which S/N can be ensured, that is, which is measurable, is about 100 to 1000. In the GM method, photon counting using a single photon avalanche diode (SPAD) or the like is often performed, and an expectation value of the number of received photons in a single shot may be smaller than 1. Histogram processing is performed using the number of received photons N accumulated by a plurality of shots. In the SP method, single shot measurement is performed using a silicon photomultiplier (SiPM) or the like. The number of photons that is measurable is one or more.

In an ideal case, since measurement time accuracy is averaged by 1/√N according to the number of received photons N, the SP method with a smaller N is affected by a laser pulse width. A probability distribution of the number of received photons follows a normal distribution in the LM method and a Poisson distribution in the GM method and the SP method. By the way, in a case where the probability distribution follows the Poisson distribution, a time waveform of the laser pulse significantly affects the measurement time accuracy. In particular, in the SP method in which single shot measurement is performed, when a pulse tail increases, a measurement result deviated from an actual distance may be obtained. In this way, in the SP method with the highest light utilization efficiency, a short pulse of the laser and pulse tail free are strongly required. The present disclosure is applicable to the above method.

Furthermore, the items described in each of the embodiment and the modifications can be combined as appropriate. Furthermore, the content of the present disclosure is not to be construed as being limited by the effects exemplified in the present specification.

The present disclosure may have the following configurations.

(1)

A MEMS device including:
a first mirror and a second mirror;
a first actuator and a second actuator; and
a first support section and a second support section, in which
the second mirror is configured as a perforated mirror having an opening at a center, and the first mirror is disposed at the opening,
the first actuator is disposed between the first mirror and the second mirror,
the first support section connects the first mirror and the first actuator, and the second support section connects the second mirror and the first actuator, and
the second mirror is connected to the second actuator via a beam.
   (2)

The MEMS device according to (1), in which
by vibrating the second actuator, the first mirror and the second mirror are integrally operated at a predetermined resonance frequency with a predetermined rotation axis, and the first actuator is non-resonantly driven in synchronization with the predetermined resonance frequency so that the first mirror operates prior to the second mirror by a predetermined phase difference on the predetermined rotation axis.
   (3)

The MEMS device according to (1) or (2), in which
the first actuator is divided into at least two portions and has a symmetrical shape with respect to a center line passing through a center of the first mirror.
   (4)

The MEMS device according to (1) or (2), in which
the first actuator is divided into at least four portions and has a symmetrical shape with respect to a center line passing through a center of the first mirror.
   (5)

The MEMS device according to any one of (1) to (4), in which
the first actuator and the second actuator include piezoelectric elements.
   (6)

The MEMS device according to any one of (1) to (5), in which
a natural vibration frequency of the first actuator is larger than the predetermined resonance frequency.
   (7)

The MEMS device according to (6), in which
the natural vibration frequency of the first actuator is larger than 20 kHz.
   (8)

A distance measurement device including:
a MEMS device;
a laser light source section;
a light receiving section; and
a measurement section configured to measure a distance to a distance measurement object on the basis of a flight time of a laser beam emitted from the laser light source section, in which
the MEMS device includes
a first mirror and a second mirror,
a first actuator and a second actuator, and
a first support section and a second support section, in which
the second mirror is configured as a perforated mirror having an opening at a center, and the first mirror is disposed at the opening,
the first actuator is disposed between the first mirror and the second mirror,
the first support section connects the first mirror and the first actuator, and the second support section connects the second mirror and the first actuator,
the second mirror is connected to the second actuator via a beam, and
the distance measurement object is irradiated with the laser beam by scanning the laser beam by the first mirror, and scattered light of the laser beam by the distance measurement object is reflected by the second mirror and enters the light receiving section.
   (9)

The distance measurement device according to (8), in which
the MEMS device is configured such that, by vibrating the second actuator, the first mirror and the second mirror are integrally operated at a first resonance frequency with a first rotation axis, and the first actuator is non-resonantly driven in synchronization with the first resonance frequency so that the first mirror operates prior to the second mirror by a first phase difference on the first rotation axis.
   (10)

The distance measurement device according to (9), in which
the MEMS device is configured such that, by vibrating the second actuator, the first mirror and the second mirror are integrally operated at a second resonance frequency with a second rotation axis orthogonal to the first rotation axis, and
the first actuator is non-resonantly driven in synchronization with the second resonance frequency so that the first mirror operates prior to the second mirror by a second phase difference on the second rotation axis.
   (11)

The distance measurement device according to (10), in which
the first phase difference and the second phase difference are changed according to a distance to the distance measurement object.
   (12)

The distance measurement device according to any one of (8) to (11), further including:
a light collecting section, in which
the scattered light of the laser beam reflected by the second mirror enters the light receiving section via the light collecting section.
   (13)

The distance measurement device according to any one of (8) to (12), in which
the light receiving section includes a silicon photomultiplier.
   (14)

A vehicle-mounted device including the distance measurement device according to any one of (8) to (13).

(15)

A method for driving a MEMS device including a first mirror and a second mirror, a first actuator and a second actuator, and a first support section and a second support section, in which the second mirror is configured as a perforated mirror having an opening at a center, and the first mirror is disposed at the opening, the first actuator is disposed between the first mirror and the second mirror, the first support section connects the first mirror and the first actuator, the second support section connects the second mirror and the first actuator, and the second mirror is connected to the second actuator via a beam, in which
by vibrating the second actuator, the first mirror and the second mirror are integrally operated at a predetermined resonance frequency with a predetermined rotation axis, and the first actuator is non-resonantly driven in synchronization with the predetermined resonance frequency so that the first mirror operates prior to the second mirror by a predetermined phase difference on the predetermined rotation axis.

### Application Examples

Next, application examples of the present disclosure will be described, but the present disclosure is not limited to the application examples to be described below. The SP method using the MEMS device 100 described in the one embodiment can highly efficiently perform distance measurement in a range of dozen centimeters to several tens of meters, and can output distance data with a latency equal to or less than one millisecond. Distance accuracy ranges from millimeters to several millimeters, and the following application is possible by utilizing characteristics of low power consumption and small size.

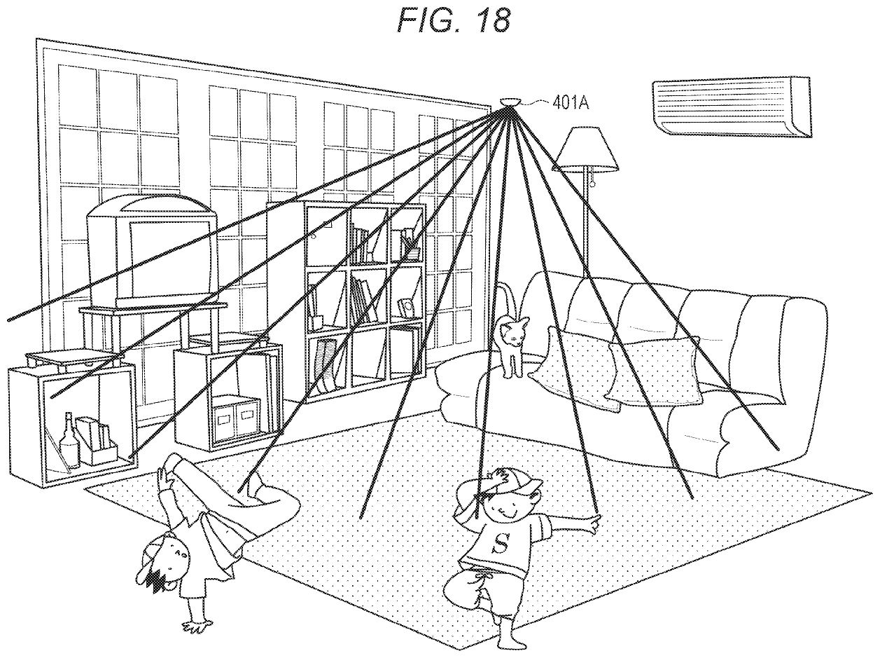

For example, by arranging the distance measurement device 401A using the MEMS device 100 of the present disclosure in a corner of a room as illustrated in FIG. 18, the entire room can be measured, and thus, an intense movement in the room or a slight movement such as moving a finger while watching a television on a sofa can be captured. As a result, an operation of an electronic device such as a home appliance or the like, gaining of an interactive game experience, and use in security are enabled. Moreover, in the scanning SP, mutual interference between devices is very small, and thus, 3D modeling can be performed in real time by performing distance measurement from two or more directions with a plurality of distance sensor systems, and a more realistic interactive experience can be provided. Because the SP method can be used even under sunlight, the experience in FIG. 18 can be expanded and provided in a wider space.

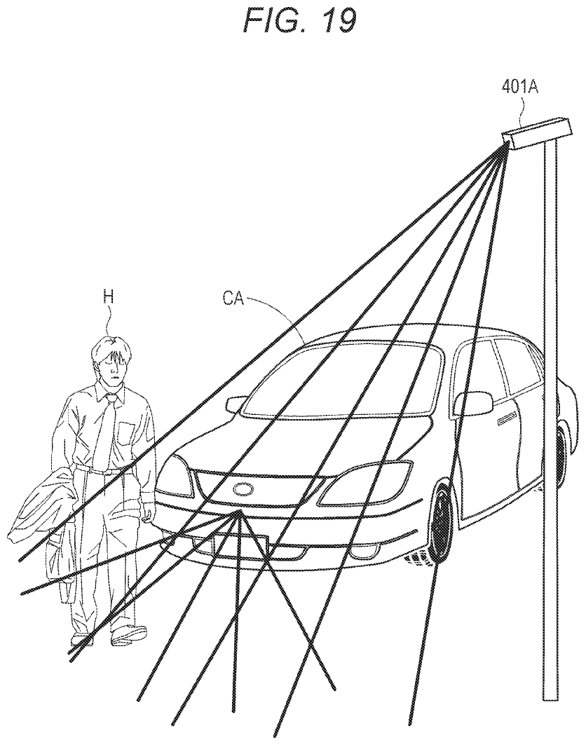

FIG. 19 is a diagram schematically illustrating an application example assuming a use scene in town centered on a person. Because the SP mounted on an automobile CA performs highly accurate distance measurement in real time, even in a case where a distance to a person is short due to being in a narrow place such as an intersection or an alley, even a slight movement can be grasped. With this arrangement, not only safety of a person H but also smooth driving of the automobile CA that performs automated driving can be supported. The SP grounded at a utility pole, a street, or the like can grasp a slight movement of a person or the like passing by without disturbing a moving route of the person H. Obtained data is real-time point cloud data, which allows an operation in consideration of privacy. For example, it provides an information service predicting a movement of the person H, detects crimes in advance, or functions as an interface in a case where a person intentionally operates a public object. Such a movement needs to capture a movement of a finger.

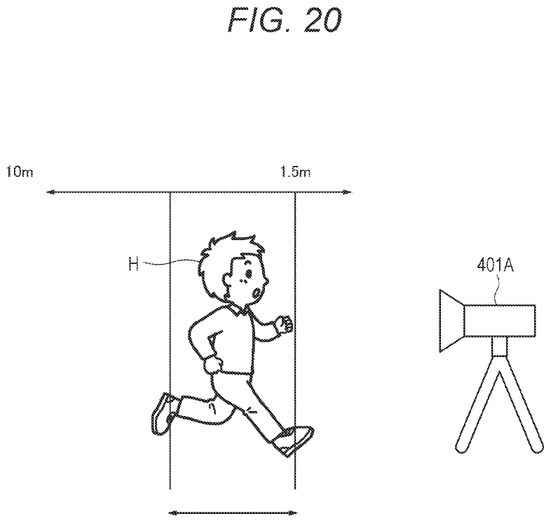

FIG. 20 is a diagram schematically illustrating an application example related to an imaging technology. Even in a lens having a very shallow focal depth such as a large camera, by the distance measurement device 401A accurately capturing positional information of a subject (for example, person H), a focal length and a focal depth can be calculated and adjustment of the lens can be automatically performed. The present disclosure is not limited to this example, and can be used for various devices that automatically control the distance. For example, the present disclosure can also be applied to machine connection, train coupling, aerial refueling of aircraft, artificial satellite connection, and the like.

Furthermore, since the distance measurement device 401A is small and has low power consumption, the distance measurement device 401A can also be applied to obstacle avoidance of an unmanned airplane such as a drone. There are many severe conditions for the flight of the drone such as forests or underground passages, and the SP that can output the point cloud data in real time enables quick and safe flight. The SP is also excellent in asset management of a structure using a drone, in which a point cloud including mega points or more per second can be obtained in real time, and further, inspection of many structures can be performed in one flight because of its low power consumption.

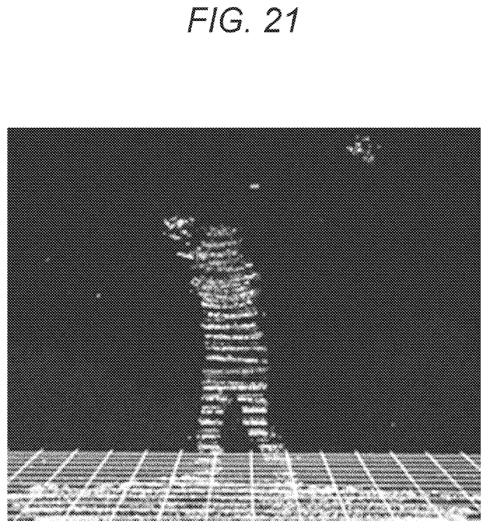

The real-time SP is compatible with sports. In judgement in sports, coaching, and the like, the point cloud of mega points or more per second captures fine movements, and a real-time interactive experience digitizes sports movements that have been sensational. For example, a degree of understanding is increased by a person wearing a wearable device such as a piezoelectric element or the like that can provide bodily sensation and the information obtained by the SP being transmitted to the person in real time. FIG. 21 illustrates an image example of a sport (for example, golf) obtained as described above. A plurality of distance sensors enables real-time 3D modeling from all directions at 360 degrees, and this can be used for swing analysis and teaching in golf, for example, and can be also used for prevention of injuries and the like. Since up to a distance of several tens of meters can be covered, the sport is not limited to golf, and use for various sports such as baseball, basketball, tennis, or gymnastics is enabled.

Furthermore, the technology according to the present disclosure can be applied to various products without being limited to the application examples described above. For example, the technology according to the present disclosure may also be implemented as a device mounted on any kind of mobile body such as an automobile, an electric automobile, a hybrid electric automobile, a motorcycle, a bicycle, a personal mobility, an airplane, a drone, a ship, a robot, a construction machine, an agricultural machine (tractor), or the like.

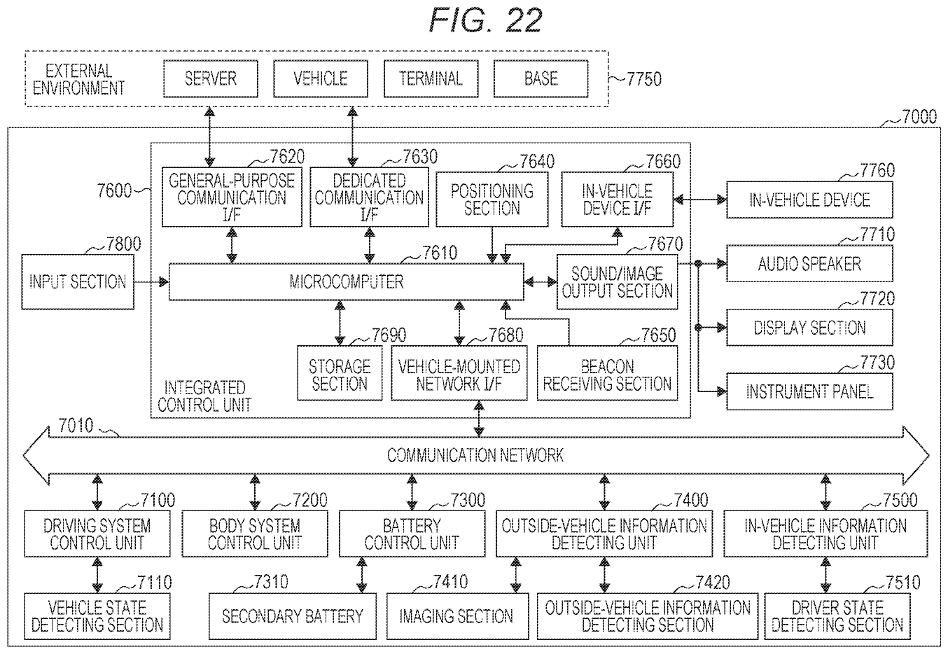

FIG. 22 is a block diagram illustrating a schematic configuration example of a vehicle control system 7000 which is an example of a mobile body control system to which the technology according to the present disclosure can be applied. The vehicle control system 7000 includes a plurality of electronic control units connected to each other via a communication network 7010. In the example illustrated in FIG. 22, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 22, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated as a functional configuration of the integrated control unit 7600. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

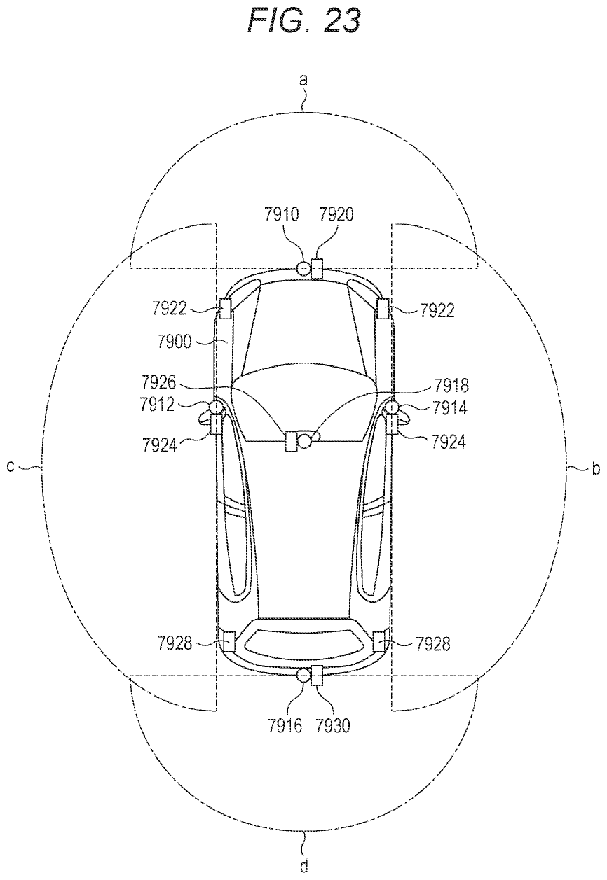

Here, FIG. 23 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 23 illustrates an example of an imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 22, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAN) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example in FIG. 22, an audio speaker 7710, a display section 7720, and an instrument panel 7730 are exemplified as output devices. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 22, at least two control units connected to each other via the communication network 7010 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the MEMS device according to the present disclosure may be applied to, for example, the outside-vehicle information detecting section.

### REFERENCE SIGNS LIST

100 MEMS device
101 First mirror
102 Second mirror
103 First support section
104 First actuator
105 Second support section
107 Second actuator
118 Opening

1. A MEMS device comprising:
a first mirror and a second mirror;
a first actuator and a second actuator; and
a first support section and a second support section, wherein
the second mirror is configured as a perforated mirror having an opening at a center, and the first mirror is disposed at the opening,
the first actuator is disposed between the first mirror and the second mirror,
the first support section connects the first mirror and the first actuator, and the second support section connects the second mirror and the first actuator, and
the second mirror is connected to the second actuator via a beam.

2. The MEMS device according to claim 1, wherein
by vibrating the second actuator, the first mirror and the second mirror are integrally operated at a predetermined resonance frequency with a predetermined rotation axis, and the first actuator is non-resonantly driven in synchronization with the predetermined resonance frequency so that the first mirror operates prior to the second mirror by a predetermined phase difference on the predetermined rotation axis.

3. The MEMS device according to claim 1, wherein
the first actuator is divided into at least two portions and has a symmetrical shape with respect to a center line passing through a center of the first mirror.

4. The MEMS device according to claim 1, wherein
the first actuator is divided into at least four portions and has a symmetrical shape with respect to a center line passing through a center of the first mirror.

5. The MEMS device according to claim 1, wherein
the first actuator and the second actuator include piezoelectric elements.

6. The MEMS device according to claim 1, wherein
a natural vibration frequency of the first actuator is larger than the predetermined resonance frequency.

7. The MEMS device according to claim 6, wherein
the natural vibration frequency of the first actuator is larger than 20 kHz.

8. A distance measurement device comprising:
a MEMS device;
a laser light source section;
a light receiving section; and
a measurement section configured to measure a distance to a distance measurement object on a basis of a flight time of a laser beam emitted from the laser light source section, wherein
the MEMS device includes
a first mirror and a second mirror,
a first actuator and a second actuator, and
a first support section and a second support section, in which
the second mirror is configured as a perforated mirror having an opening at a center, and the first mirror is disposed at the opening,
the first actuator is disposed between the first mirror and the second mirror,
the first support section connects the first mirror and the first actuator, and the second support section connects the second mirror and the first actuator,
the second mirror is connected to the second actuator via a beam, and
the distance measurement object is irradiated with the laser beam by scanning the laser beam by the first mirror, and scattered light of the laser beam by the distance measurement object is reflected by the second mirror and enters the light receiving section.

9. The distance measurement device according to claim 8, wherein
the MEMS device is configured such that, by vibrating the second actuator, the first mirror and the second mirror are integrally operated at a first resonance frequency with a first rotation axis, and the first actuator is non-resonantly driven in synchronization with the first resonance frequency so that the first mirror operates prior to the second mirror by a first phase difference on the first rotation axis.

10. The distance measurement device according to claim 9, wherein
the MEMS device is configured such that, by vibrating the second actuator, the first mirror and the second mirror are integrally operated at a second resonance frequency with a second rotation axis orthogonal to the first rotation axis, and the first actuator is non-resonantly driven in synchronization with the second resonance frequency so that the first mirror operates prior to the second mirror by a second phase difference on the second rotation axis.

11. The distance measurement device according to claim 10, wherein
the first phase difference and the second phase difference are changed according to a distance to the distance measurement object.

12. The distance measurement device according to claim 8, further comprising:
a light collecting section, wherein
the scattered light of the laser beam reflected by the second mirror enters the light receiving section via the light collecting section.

13. The distance measurement device according to claim 8, wherein
the light receiving section includes a silicon photomultiplier.

14. A vehicle-mounted device comprising the distance measurement device according to claim 8.

15. A method for driving a MEMS device including a first mirror and a second mirror, a first actuator and a second actuator, and a first support section and a second support section, in which the second mirror is configured as a perforated mirror having an opening at a center, and the first mirror is disposed at the opening, the first actuator is disposed between the first mirror and the second mirror, the first support section connects the first mirror and the first actuator, the second support section connects the second mirror and the first actuator, and the second mirror is connected to the second actuator via a beam, wherein
by vibrating the second actuator, the first mirror and the second mirror are integrally operated at a predetermined resonance frequency with a predetermined rotation axis, and the first actuator is non-resonantly driven in synchronization with the predetermined resonance frequency so that the first mirror operates prior to the second mirror by a predetermined phase difference on the predetermined rotation axis.
